(19) United States
(12) Patent Application Publication
(10) Pub. No.: US 2014/0155305 A1
(43) Pub. Date: Jun. 5, 2014

(54) THICKENING OF FLUIDS

(71) Applicant: SCHLUMBERGER TECHNOLOGY CORPORATION, Surgar Land, TX (US)

(72) Inventors: Robert Seth HARTSHORNE, Burwell (GB); Karene Guilaine URGIN, Cambridge (GB); Lynne Patricia CRAWFORD, Harlow (GB); Philip F. SULLIVAN, Bellaire, TX (US); Paul Richard HOWARD, Sugar Land, TX (US); Trevor Lloyd HUGHES, Cambridge (GB); Timothy G. J. JONES, Cottenham (GB)

(73) Assignee: SCHLUMBERGER TECHNOLOGY CORPORATION, Sugar Land, TX (US)

(21) Appl. No.: 14/096,718

(22) Filed: Dec. 4, 2013

Related U.S. Application Data
(60) Provisional application No. 61/733,325, filed on Dec. 4, 2012.

(51) Int. Cl. C09K 8/68

(52) U.S. Cl. CPC C09K 8/685
USPC 507/211

(57) ABSTRACT

An aqueous solution comprising a thickening polymer with diol groups distributed along it, such as guar or other polysaccharide, is cross linked with a cross-linker which contains a plurality of boroxole groups of the partial formula

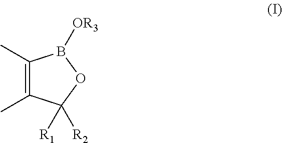

wherein R₁ is hydrogen or a substituent group or an attachment to the remainder of the cross-linker molecule, R₂ is hydrogen or a substituent group, R₃ is hydrogen or an aliphatic or aromatic group and the carbon atoms joined by a double bond are part of an aromatic ring. The thickened fluid may be a wellbore fluid and may be a hydraulic fracturing fluid in which a particulate proppant is suspended.

### CROSS-REFERENCE TO RELATED APPLICATION

The present application claims the benefit of U.S. Provisional Application Ser. No. 61/733,325, filed Dec. 4, 2012, which application is incorporated herein, in its entirety, by reference.

### BACKGROUND

It is well-known to viscosify aqueous liquids with a polymer which may itself act as a thickener, but which is cross-linked with a cross-linking agent in order to increase viscosity further. There are many industries and products where thickening of aqueous liquid is required. One area of application is in connection with the extraction of hydrocarbons such as oil and natural gas from a subterranean reservoir by means of a drilled well that penetrates the hydrocarbon-bearing reservoir formation. In this field, one commercially very significant application of thickened fluids is for hydraulic fracturing of the formation. Viscosity of the fluid assists in controlling leak-off of the fluid into the formation, it aids in the transfer of hydraulic fracturing pressure to the rock surfaces and it facilitates the suspension and transfer into the formation of proppant materials that remain in the fracture and thereby hold the fracture open when the hydraulic pressure is released.

Further applications of thickened fluids in connection with hydrocarbon extraction are acidizing, control of fluid loss, diversion, zonal isolation, and the placing of gravel packs. Gravel packing is a process of placing a volume of particulate material, frequently a coarse sand, within the wellbore and possibly extending slightly into the surrounding formation. The particulate material used to form a gravel pack may be transported into place in suspension in a thickened fluid. When it is in place, the gravel pack acts as a filter for fine particles so that they are not entrained in the produced fluid.

Common examples of polymeric thickening agents used in the thickened fluids mentioned above are galactomannan gums, in particular guar and substituted guars such as hydroxypropyl guar and carboxymethylhydroxypropyl guar, cellulosic polymers such as hydroxyethyl cellulose and other polysaccharides. Crosslinking of the polymeric materials then serves to increase the viscosity and proppant carrying ability of the fluid, as well as to increase its high temperature stability. Available crosslinking agents include soluble boron, zirconium, and titanium compounds. Compounds of other metals have also been used.

The viscosity of these crosslinked gels can be reduced by mechanical shearing (i.e., they are shear thinning) but gels cross-linked with boron compounds have the advantage that they will reform spontaneously after exposure to high shear. This property of being reversible makes boron-crosslinked gels particularly attractive and they have been widely used.

Boric acid, inorganic borate salts and condensed salts such as borax are well established as cross-linking agents for guar and other polymers used to thicken wellbore fluids. A limitation is that inter-molecular guar crosslinks will only occur if individual guar molecules are close enough to each other for the borate to span the inter-chain gap. This results in a requirement for the guar concentration in solution to exceed a minimum concentration which is the critical overlap concentration (C*).

When hydraulic fracturing is carried out, it is customary to break the viscosified fluid and produce it back to the surface after the fracturing operation and proppant placement. Breaking the fluid is done by cutting the polymer chains of the guar or other polymer by means of oxidative or enzymatic chemical breakers. This creates insoluble residues which remain in the reservoir and may damage proppant pack conductivity.

Use of larger cross-linked molecules which are organic compounds with boronic acid groups has been suggested in a number of documents. See, for example, Coveney et al., “Novel Approaches to Cross-linking High Molecular Weight Polysaccharides: Application to Guar-based Hydraulic Fracturing Fluids,” Molecular Simulation, vol. 25, pp. 265-299 (2000). Sun and Qu, “High Efficiency Boron Crosslinkers for Low-Polymer fracturing Fluids,” Society of Petroleum Engineers Paper SPE 140817 reported that the size of the crosslinker species affects the rheological properties of crosslinked fluids. The paper disclosed that multifunctional water soluble polymeric crosslinkers could be used to crosslink guar to provide the equivalent viscosity to a conventional guar-boric acid system, but with reduced concentration of guar. Other documents have also proposed to use polymer cross-linkers with boronic acid groups, for example U.S. Pat. No. 7,405,183.

In WO2012/071462, phenylboronic acid derivatised nanoparticles were demonstrated to crosslink aqueous guar solutions effectively, providing reductions in concentrations of guar and of boron relative to a fluid thickened with guar and inorganic borate.

### SUMMARY

This summary is provided to introduce a selection of concepts that are further described below. This summary is not intended to limit the scope of the subject matter claimed.

Broadly, this disclosure provides a thickened aqueous fluid comprising a thickening polymer with diol groups distributed along it and a cross-linker for that polymer where the cross-linker is a molecule including a plurality of groups of the partial formula

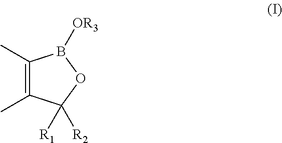

wherein R₁ is hydrogen or a substituent group or an attachment to the remainder of the cross-linker molecule, R₂ is hydrogen or a substituent group, R₃ is hydrogen or an aliphatic or aromatic group and the carbon atoms joined by a double bond are part of an aromatic ring, which may be a single ring or part of a fused ring system.

The cross-linker molecule can also be visualised as including groups of formula

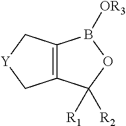

wherein the portion

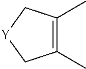

denotes a five- or six-membered aromatic ring, which may be a single ring or part of a fused ring system.

The five-membered ring containing a boron atom and an oxygen atom

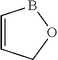

is referred to as a boroxole although other names including oxyborole have been used in the literature. Here, this five-membered ring is fused with a benzene ring or some other aromatic ring. An unsubstituted boroxole ring fused with an unsubstituted benzene ring is the compound benzoboroxole:

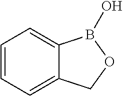

The cross-linker molecule contains a plurality of the boroxole groups and these may be attached to the remainder of the cross-linker molecule through the aromatic ring or at the R₁ position, so that the cross linker molecule may be represented as

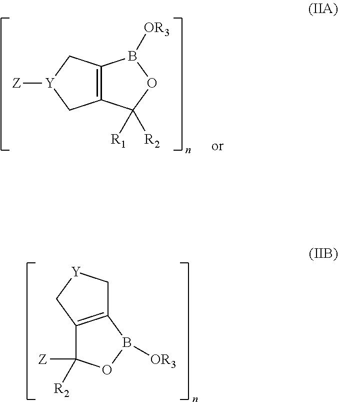

where Z denotes structure to which the groups are attached. The cross linker may be a small molecule or a polymer, and either of these may be water soluble for use in aqueous solution. A further possibility is that the cross linker is nanoparticles, used as a latex, i.e., an aqueous suspension.

Snyder et al., J. Am. Chem. Soc., Vol. 80, pp. 835-838 (1958) reported that the boroxole ring in benzoboroxole was strongly resistant to acid hydrolysis. Other authors have subsequently affirmed the remarkable stability of the boroxole ring.

A boroxole group can react with diols. The reaction is understood to lead to an anion, thus

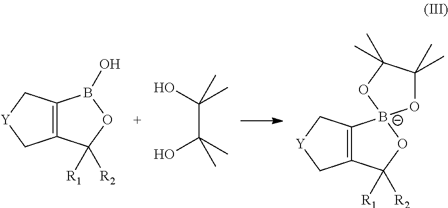

In the present invention a cross-linker which includes a plurality of boroxole groups can bind to, and cross-link, a plurality of molecules of a thickening polymer which contains diol groups. Diol groups are present in a number of polysaccharides known as thickening polymers, including guar. A polymer with an average of two boroxole groups attached to it per polymer molecule can serve as a crosslinker, but polymer to e used as a crosslinker may have a higher average number of boroxole grouos attached, such as at least 3 or at least 4.

The pH of a thickened fluid may be above pH 9 or may possibly be no greater than pH 9 and possibly in a range from pH 7 to pH 8.5. This is beneficial in that it allows aqueous solutions of thickening polymer to be made using a range of water supplies which may be available, including water with a content of calcium and/or magnesium which would form an unwanted insoluble precipitate or scale at pH above pH 9.

The thickened aqueous liquid may be a wellbore fluid which is mixed at the surface and pumped down a wellbore, or may be a wellbore fluid which is formed below ground by pumping its constituents down a wellbore and allowing them to mix below ground.

The present invention also provides a method of thickening an aqueous fluid comprising incorporating into an aqueous liquid:

a water-soluble polymer with diol groups distributed along the polymer chain, and

a cross-linker which is a molecule including a plurality of groups of the partial formula (I) above.

This method may be part of a method of treating a wellbore where the method also comprises pumping the aqueous liquid, the water-soluble polymer and the crosslinker down a wellbore.

The wellbore treatment may be a hydraulic fracturing job in which particulate proppant is suspended in the thickened fluid or may be the delivery of a gravel pack for which particulate material is suspended in the thickened fluid.

### BRIEF DESCRIPTION OF THE DRAWINGS

FIGS. 1 to 4 show measurements of viscosity over a range of shear rates for compositions thickened with a cross linker as disclosed in Example 1 below, at three values of pH and four temperatures;

FIGS. 5 to 8 show measurements of viscosity over a range of shear rates for a composition thickened with a cross linker as disclosed in Example 1 below and a comparative composition thickened with boric acid, both at pH 11 and at four temperatures;

FIGS. 9 to 12 show measurements of viscosity over a range of shear rates for a composition thickened with a cross linker as disclosed in Example 3 below at four values of pH plus a comparative composition thickened with boric acid at pH 11, at four temperatures; and

FIGS. 13 to 16 show measurements of viscosity over a range of shear rates for a composition thickened with a cross linker as disclosed in Example 3 below and a comparative composition thickened with boric acid, at pH 9 and at pH 11 and at two temperatures.

### DETAILED DESCRIPTION

The present invention calls for a cross-linker molecule which contains multiple boroxole groups. The cross-linker molecule may be a polymer with boroxole groups distributed along the polymer chain, or it may be a polymer with boroxole groups attached to side chains. Boroxole groups may be attached at positions distributed along a polymer chain or may be at positions at each end of a polymer chain. The cross-linker may be a nano particle with multiple boroxole groups attached to the exterior of the nano particle. A different possibility is that the cross-linker is a small molecule with a molecular weight of 500 or less, incorporating two or perhaps three or four boroxole groups. In all of these possibilities, the boroxole group may be attached to the remainder of the cross-linker molecule through the aromatic ring represented as

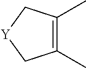

above or may be attached at the position R₁ in formulae above. One possibility is that the aromatic ring may bear an amino substituent, which becomes attached to the remainder of the crosslinker as an amide group.

In the formula (I) and other formulae above, R₃ on a boroxole ring may be hydrogen. This may be convenient as the simplest possibility for R₃ and will enable the boroxole group to react directly with diol groups in accordance with the reaction scheme (III) above. However, it is possible that the R₃ group is an aliphatic or aromatic group which can be removed (forming R₃—OH) in the aqueous liquid. Such an R₃ group might be removed by hydrolysis before reaction with a diol group or might be removed as part of reaction with the diol group.

The groups R₁ and R₂ in the formula (I) and other formulae above may be hydrogen. However, one or both of them could be an organic moiety such as alkyl or aryl group or could be some other substituent. For instance R₁ could be methyl while R₂ is hydrogen or both of them could be methyl.

### Synthetic Strategies

There are a variety of approaches for making a crosslinker with a plurality of boroxole groups. One approach is to make a compound containing boroxole groups and then attach this compound to another part of the cross-linker There are a number of published synthetic routes leading to the formation of a boroxole ring. Some routes begin with phenyl boronic acid which has substitution at a position ortho to the boronic acid group.

Snyder et al (as above) disclosed bromination of ortho methyl phenyl boronic acid followed by hydrolysis to orthohydroxymethyl phenyl boronic acid which readily dehydrates to benzoboroxole. Lennarz et al., J. Am. Chem. Soc., Vol. 82, pp. 2172-2175 (1960) disclosed subsequent nitration of the benzene ring of benzoboroxole followed by Raney nickel hydrogenation to an amino substituent. Overall this is:

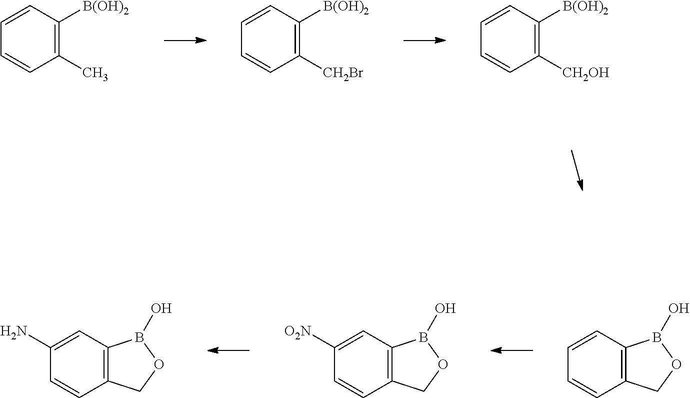

Another route to boroxoles which involves an ortho substituent on phenyl boronic acid was described by Tschampel et al., in J. Org. Chem., vol. 29, pp. 2168-2172 (1964). Ortho methyl phenyl boronic acid was dibrominated and then hydrolysed to orthoformyl phenyl boronic acid which is then reacted with a nucleophile to form a benzoboroxole with a substituent on the boroxole ring:

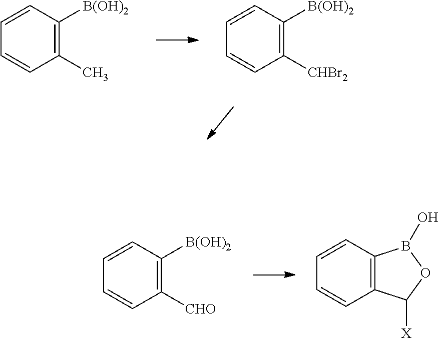

Tschampel et al. reported reactions of several materials with the ortho formyl phenyl boronic acid to preparing compounds in which X was as follows:

| Reactant | Substituent X |
|---|---|
| Isopropylidene malonate | —CH₂CO₂H |
| (also malonic acid) | |
| Nitromethane | —CH₂NO₂ |
| Sodium cyanide | —CN |
| Sodium cyanide followed by | —CO₂H |
| hydrolysis of product | |

Kumar et al., in Tetrahedron Letters, Vol. 51 (2010) pp. 4482-4485 have described reaction of orthoformyl phenyl boronic acid with compounds including acrylates and acrylonitrile to form benzoboroxoles with acrylate groups as substituents on the boroxole ring.

A synthetic route which forms the boroxole ring by insertion of boron has been described by Zhdankin et al., in Tetrahedron Letters, vol. 40, pp. 6705-6708 (1999). The starting material is an orthobromo benzyl alcohol which is reacted with butyl lithium to give a lithium compound as an intermediate which is then reacted with triisopropyl borate:

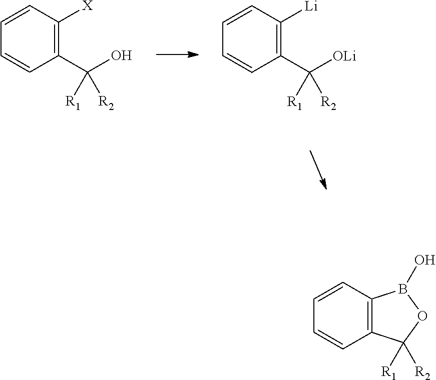

Zhdankin et al. reported carrying out this reaction when X was Br or I, R₁ was the same as R₂ and was H, CH₃ or CF₃. Gunasekara et al., Tetrahedron, vol. 63, pp. 9401-9405 (2007) have described a variant of this reaction using sodium hydride before butyl lithium, and made further compounds in which R₁ was vinyl, allyl, phenyl or n-decyl while R₂ was hydrogen.

A more detailed review of literature methods for synthesis of boroxoles is provided by Adamczyk-Wozniak et al., in J. Organometallic Chemistry, vol. 694, pp. 3533-3541 (2009). A different synthetic approach, using catalysed trimerisation of alkynes has been reported by Yamamoto et al., J. Am. Chem. Soc., Vol. 127, pp. 9625-9631 (2005).

One approach to incorporating a benzoboroxole into a larger molecule is to use a benzoboroxole with a functional substituent on the benzene ring. A plurality of these molecules are reacted with the another compound, leading to a cross-linker with multiple boroxole groups. More specifically, to make a cross-linker in this way an amino benzoboroxole with an amino substitutuent may be reacted with a copolymer containing maleic anhydride residues. The benzoboroxole becomes attached to the polymer through an amide linkage.

A crosslinker may be derived from a compound with a polyoxyalkylene chain such as a straight chain or branched polyethylene glycol, by peptidic coupling using 2-[(1-hydroxy-1,3-dihydro-2,1-benzoxaborol-6-yl)oxy]acetic acid of formula

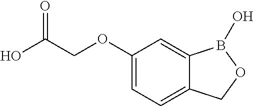 [SMILES: O=C(O)COc1ccc2c(c1)B(O)OC2]

or by reductive amination using the corresponding 2-[(1-hydroxy-1,3-dihydro-2,1-benzoxaborol-6-yl)oxy]acetaldehyde of formula

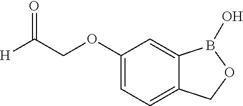 [SMILES: O=CCOc1ccc2c(c1)B(O)OC2]

Both of the materials above are commercially available from Aces Pharma Inc, Princeton, N.J.

Examples of straight and branched polyethylene glycols to which boroxole groups may be attached by these reactions are PEG 1000, PEG10000, 4-armPeg10000, 6-armPeg10000 and 8-armPeg10000.

Another approach is to make benzoboroxole with an attached vinyl or acrylate group by the procedures of Kumar, Zhdankin or Gunasekara above and copolymerise this with another monomer such as acrylamide or maleic anhydride.

A further approach would be to prepare a molecule containing a plurality of ortho bromobenzyl alcohol groups and then carry out the reaction described by Zhdankin et al. as shown above to introduce boroxole groups.

For preparing a water soluble cross linker, it may be helpful to prepare a benzoboroxole with a reactive functional group which is then attached to another part of the crosslinker molecule by means of a group which can be formed under mild conditions, such as an ester or amide linkage.

The structure, boron content and water solubility of a cross-linker may be such that a saturated solution of the cross linker in a phosphate buffer solution at pH 9 contains boron in an amount which is at least five ppm and possibly more such as at least 10 or at least 50 ppm.

A polysaccharide which is to be crosslinked provides diol groups for binding to a boroxole group. Polysaccharides generally have hydroxyl groups on adjacent carbon atoms and some sugar residues provide adjacent carbon atoms with hydroxyl groups in cis-conformation which may position the hydroxyl groups for attachment to the boron atom of a boroxole ring. Some hexose residues may position hydroxyl groups at the 4 and 6 positions for attachment to the boron atom. A polysaccharide may be a galactomannan gum, and the commonly used example of such gums is guar which has a linear chain of β 1,4-linked mannose residues to which galactose residues are 1,6-linked at alternate mannose residues. The pyranose forms of mannose have at least two adjacent carbon atoms bearing hydroxyl groups in cis-conformation. The pyranose forms of galactose have hydroxyl groups in cis-conformation on the carbon atoms at the 3 and 4 positions. Various chemical modifications of guar are available and may be used. One is the introduction of hydroxyl-alkyl substituent groups. Hydroxypropyl guar is sometimes referred to as “hydrated guar”. Another well known substituent group is carboxyalkyl, usually carboxymethyl.

Other polysaccharides which have been used as thickening agents, and which may be used in embodiments of this invention, are xanthan, scleroglucan, and diutan. These may also be chemically modified with hydroxyalkyl or carboxyalkyl groups.

Concentration of polysaccharide or chemically modified polysaccharide in the fluid may be from 0.5 or 1 g/liter up to 5 or possibly up to 10 g/liter, but quite possibly not over 2 g/liter. The concentration of cross linker in the thickened fluid may be such that the fluid contains from 0.5 to 50 ppm elemental boron and possibly 0.5 up to 10 ppm.

A wellbore fluid embodying the present invention may include other constituents in addition to those already mentioned. One additional constituent which may be included is a breaker. The purpose of this component is to “break” or diminish the viscosity of the fluid so that this fluid is more easily recovered from the formation during cleanup. The breaker degrades the polymer to reduce its molecular weight. If the polymer is a polysaccharide, the breaker may be a peroxide with oxygen-oxygen single bonds in the molecular structure. These peroxide breakers may be hydrogen peroxide or other material such as a metal peroxide that provides peroxide or hydrogen peroxide for reaction in solution. A peroxide breaker may be a so-called stabilized peroxide breaker in which hydrogen peroxide is bound or inhibited by another compound or molecule(s) prior to its addition to water but is released into solution when added to water.

Examples of suitable stabilized peroxide breakers include the adducts of hydrogen peroxide with other molecules, and may include carbamide peroxide or urea peroxide (CH₄N₂O.H₂O₂), percarbonates, such as sodium percarbonate (2Na₂CO₃.3H₂O₂), potassium percarbonate and ammonium percarbonate. The stabilized peroxide breakers may also include those compounds that undergo hydrolysis in water to release hydrogen peroxide, such sodium perborate. A stabilized peroxide breaker may be an encapsulated peroxide. The encapsulation material may be a polymer that can degrade over a period of time to release the breaker and may be chosen depending on the release rate desired.

Degradation of the polymer can occur, for example, by hydrolysis, solvolysis, melting, or other mechanisms. The polymers may be selected from homopolymers and copolymers of glycolate and lactate, polycarbonates, polyanhydrides, polyorthoesters, and polyphosphacenes. The encapsulated peroxides may be encapsulated hydrogen peroxide, encapsulated metal peroxides, such as sodium peroxide, calcium peroxide, zinc peroxide, etc., or any of the peroxides described herein that are encapsulated in an appropriate material to inhibit or reduce reaction of the peroxide prior to its addition to water.

The peroxide breaker, stabilized or unstabilized, is used in an amount sufficient to break the heteropolysaccharide polymer or diutan. This may depend upon the amount of heteropolysaccharide used and the conditions of the treatment. Lower temperatures may require greater amounts of the breaker. In many, if not most applications, the peroxide breaker may be used in an amount of from about 0.001% to about 20% by weight of the treatment fluid, more particularly from about 0.005% to about 5% by weight of the treatment fluid, and more particularly from about 0.01% to about 2% by weight of the treatment fluid. The peroxide breaker may be effective in the presence of mineral oil or other hydrocarbon carrier fluids or other commonly used chemicals when such fluids are used with the heteropolysaccharide.

Breaking aids or catalysts may be used with the peroxide breaker. The breaker aid may be an iron-containing breaking aid that acts as a catalyst. The iron catalyst is a ferrous iron (II) compound. Examples of suitable iron (II) compounds include, but are not limited to, iron (II) sulfate and its hydrates (e.g., ferrous sulfate heptahydrate), iron (II) chloride, and iron (II) gluconate. Iron powder in combination with a pH adjusting agent that provides an acidic pH may also be used. Other transition metal ions can also be used as the breaking aid or catalyst, such as manganese (Mn).

Other materials which may be included in a wellbore fluid include electrolyte, such as an organic or inorganic salt, friction reducers to assist flow when pumping and surfactants.

A wellbore fluid may be a so-called energized fluid formed by injecting gas (most commonly nitrogen, carbon dioxide or mixture of them) into the wellbore concomitantly with the aqueous solution. Dispersion of the gas into the base fluid in the form of bubbles increases the viscosity of such fluid and impacts positively its performance, particularly its ability to effectively induce hydraulic fracturing of the formation, and capacity to carry solids. The presence of the gas also enhances the flowback of the fluid when this is required. In a method of this invention the wellbore fluid may serve as a fracturing fluid or gravel packing fluid and may be used to suspend a particulate material for transport down wellbore. This material may in particular be a proppant used in hydraulic fracturing or gravel used to form a gravel pack. The commonest materials used as proppant or gravel are sand of selected size but ceramic particles and a number of other materials are known for this purpose.

Wellbore fluids in accordance with this invention may also be used without suspended proppant in the initial stage of hydraulic fracturing. Further applications of wellbore fluids in accordance with this invention are in modifying the permeability of subterranean formations, and the placing of plugs to achieve zonal isolation and/or prevent fluid loss.

For some applications, a fiber component may be included in the treatment fluid to achieve a variety of properties including improving particle suspension, and particle transport capabilities, and gas phase stability. Fibers used may be hydrophilic or hydrophobic in nature. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be present at concentrations from about 1 to about 15 grams per liter of the liquid phase, in particular the concentration of fibers may be from about 2 to about 12 grams per liter of liquid, and more particularly from about 2 to about 10 grams per liter of liquid.

### Example 1

A water soluble linear polymeric crosslinker was synthesized starting with a co-polymer of styrene and maleic anhydride. The maleic anhydride residues in this copolymer will react with nucleophiles.

The co-polymer was reacted with aminobenzoboroxole (available as “amino-2-hydroxymethylphenylboronic acid, HCl, dehydrate” from Combi-Blocks, Inc., Chester, Pa.). In a second step the crude polymer was dissolved in aqueous sodium hydroxide to open any unreacted maleic anhydride groups. The two-step reaction is thus:

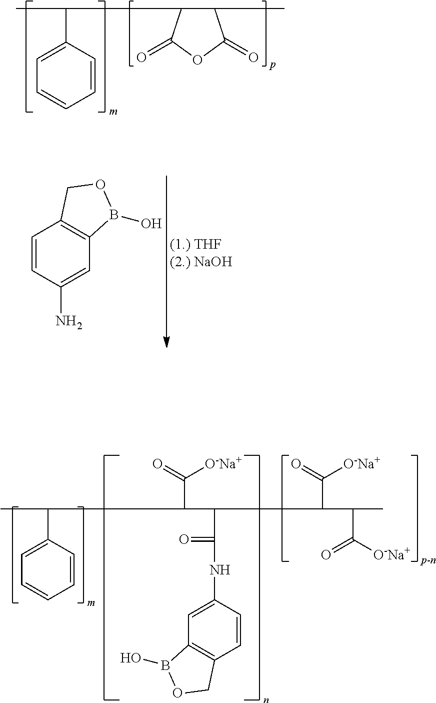

The polystyrene-co-maleic anhydride copolymer and other materials except the aminobenzoboroxole are available from Sigma Aldrich. The procedure for the reactions above was as follows. A solution of aminobenzoboroxole hydrochloride in (500 mg, 2.69 mmol, 10 equiv) in 5 mL of tetrahydrofuran (THF) was mixed with 3 mL of an aqueous solution of NaOH (1M) to convert the amino groups from salt form to free base form. The mixture was stirred at room temperature for 1 hour. A further 15 mL of THF was added followed by the polystyrene-co-maleic anhydride copolymer (Mn˜1600, 432 mg, 0.27 mmol, 1 equiv) and the mixture was stirred under reflux at 60° C. overnight. After removal of THF, 10 mL of water was added then a few mL of NaOH solution (1M) was added until pH reached 11. The solution was stirred at 60° C. for 1.5 hours and under these conditions the alkali opened any remaining maleic anhydride rings. Some HCl solution was added until pH reached 3, precipitating the product and leaving unreacted materials in solution. After centrifugation a brown solid was collected. This was redissolved in water with NaOH solution added until pH reached 11. The product polymer (designated PScoMA-BBX) was purified by dialysis and freeze-dried overnight.

The amount of boron within the polymer was measured by ICP-MS which showed that the compound contained an average of 2 boron atoms per chain. Aqueous solutions were prepared containing 0.2 wt % guar and 0.2 wt % of the above PScoMA-BBX polymer containing boroxole groups. This provided approximately 30 ppm boron in solution. These solutions were prepared with pH 9, pH 10 and pH 11. It was observed that all these solutions were visibly more viscous then a 0.2% wt % guar solution with no cross linker and also observed that viscosity increased with pH.

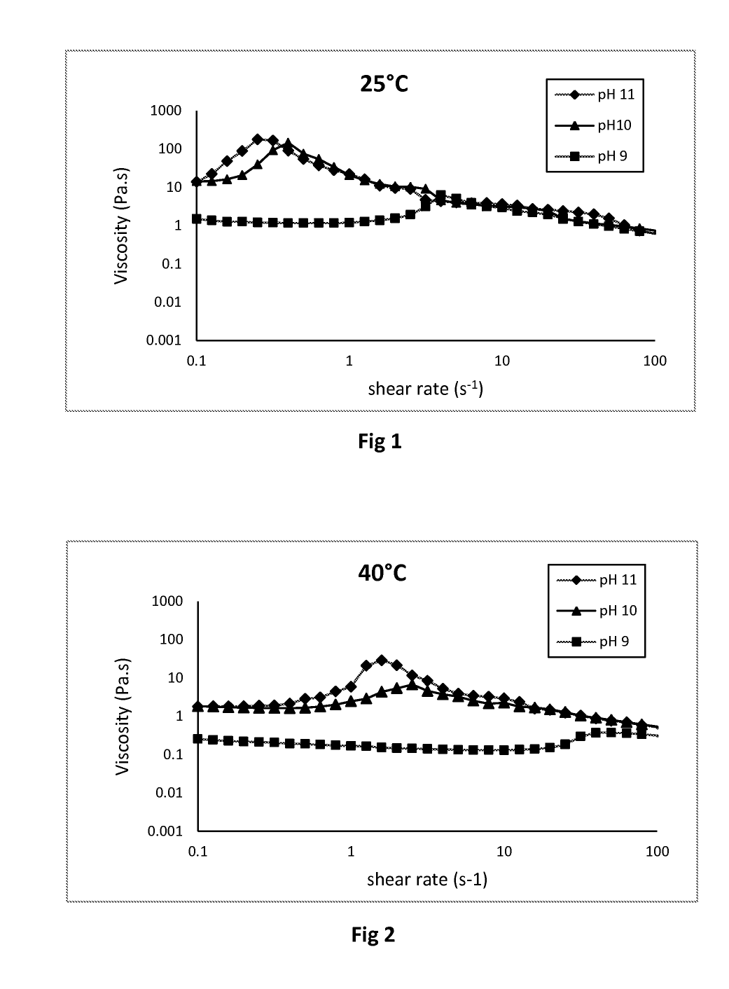

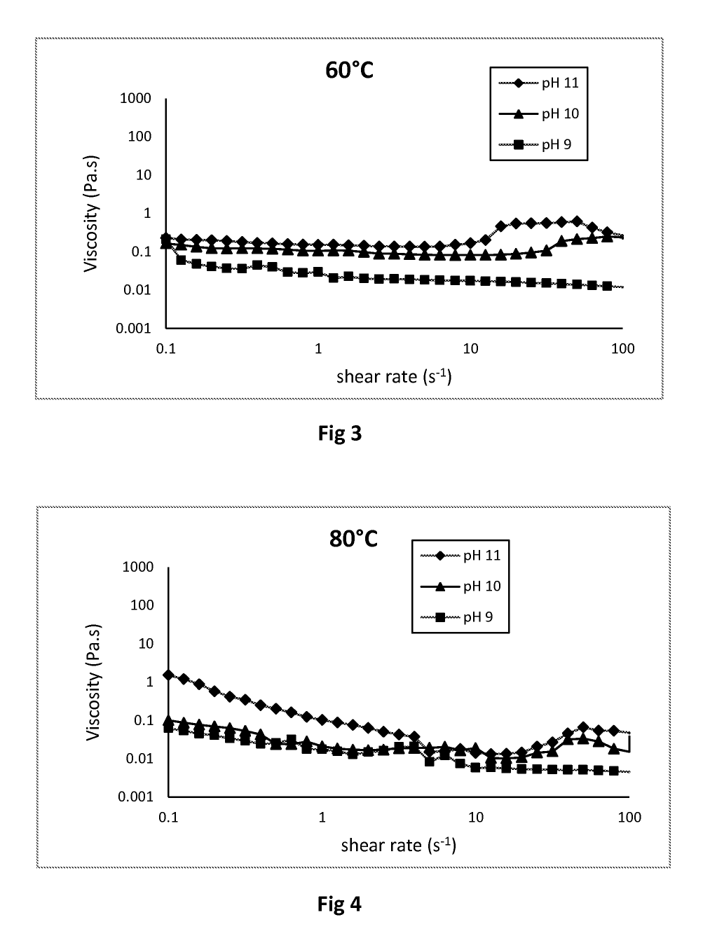

Viscosities of the solutions were measured at various temperatures and shear rates. Results are shown in FIGS. 1 to 4. It can be seen that crosslinking of the guar and consequent enhancement of viscosity increases as pH is increased from pH 9 to pH 11, but is reduced by rising temperature.

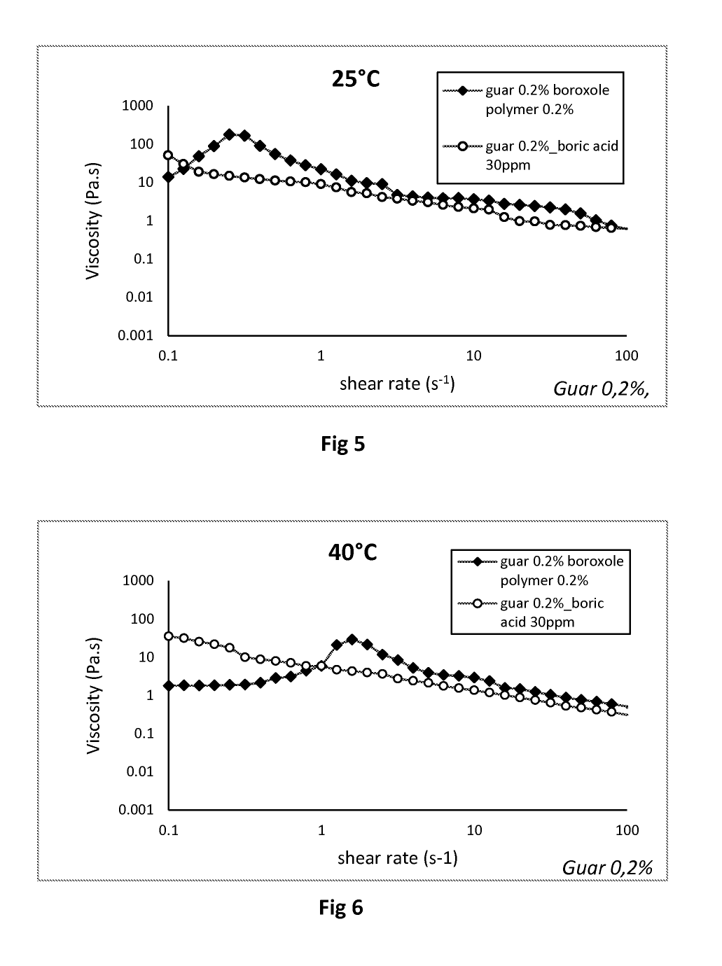

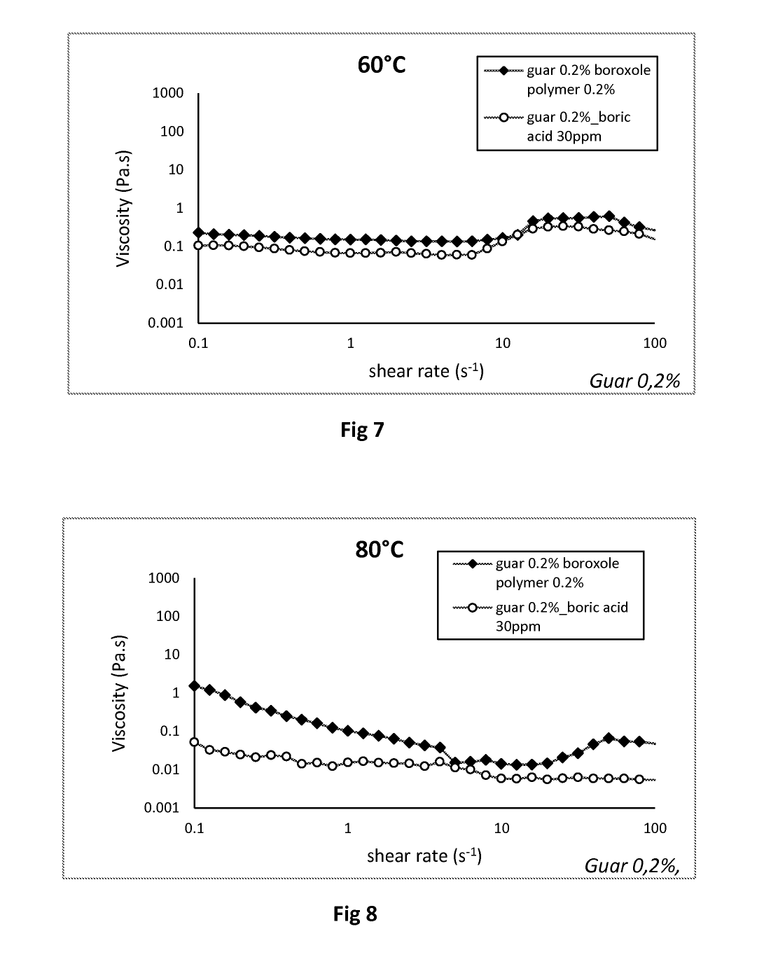

A comparative solution was prepared at pH 11 containing 0.2 wt % guar and sufficient boric acid to provide 30 ppm boron in solution. Viscosities of this comparative solution were also measured. FIGS. 5 to 8 show results at four temperatures for a solution thickened with the PScoMA-BBX polymer at pH 11 and for a comparative solution thickened with boric acid at pH 11. It can be seen that the crosslinking PScoMA-BBX polymer is achieving a similar extent of viscosity increase to the inorganic borate.

### Example 2

Crosslinker nanoparticles bearing boroxole groups were prepared in two stages. In a first stage, a nanolatex with reactive benzyl chloride functionality was prepared. Cetyltrimethylammonium bromide (CTAB) and polyethylene glycol (PEG 6000) were suspended in 122.5 ml of pH 7 phosphate buffer. A mixture of monomers containing 3.2 g of styrene (3.1×10⁻² mol), 4.1 g of divinylbenzene (3.1×10⁻² mol) and 1.7 g of vinylbenzyl chloride (1.1×10⁻² mol) was then added. The concentrations in the resulting prepolymerisation mixture were:

| | |
|---|---|
| CTAB | 15 millimol/litre |
| PEG 6000 | 2.86 millimol/litre |
| Styrene | 76 millimol/litre |
| Divinyl benzene | 5 millimol/litre |
| Vinylbenzyl chloride | 76 millimol/litre. |

Nitrogen gas was passed through this prepolymerisation mixture to remove oxygen and the mixture was then heated to 75° C. Polymerisation was initiated by the addition of an aqueous solution containing 2,2′-azobis(2-methylpropionamidine)dihydrochloride (V-50). The polymerization was performed at 75° C. for 18 h and resulted in an opalescent solution. The freshly prepared latex was purified by dialysis against ultrapure water.

15 ml of the latex was then functionalised with benzoboroxole moieties. The purified latex was first diluted 2-fold with water and its pH was adjusted to pH 7.4 by adding NaOH. Aminobenzoboroxole (290 mg of amino-2-hydroxymethylphenylboronic acid, HCl, dehydrate from Combi-Blocks, Inc., Chester, Pa.) was neutralised by titration with NaOH to pH 7.4 and added to the latex. The mixture was then stirred for three days at room temperature of 22° C. The modified latex was dialysed against ultrapure water and the absence of unbound boronic acid was confirmed by showing no colour change with alizarin red.

### Example 3

A water soluble linear polymeric crosslinker was synthesized starting with a sodium carboxymethylcellulose. This has a high water solubility and its carboxylic acid groups will react with amino groups in the presence of coupling agent.

The carboxymethylcellulose was reacted with aminobenzoboroxole (available as “amino-2-hydroxymethylphenylboronic acid, HCl, dehydrate” from Combi-Blocks, Inc., Chester, Pa.) in the presence of 1-ethyl-3-(3-dimethylaminopropyl)-carbodiimide hydrochloride (available from sigma Aldrich). The reaction is thus:

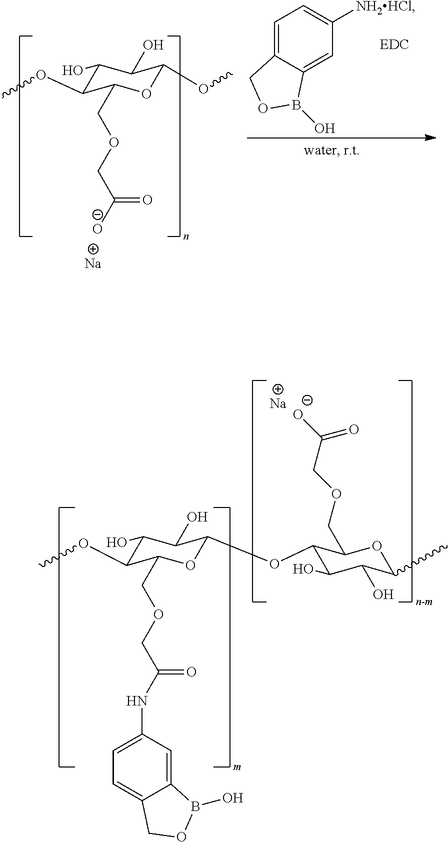

The sodium carboxymethylcellulose and other materials except the aminobenzoboroxole are available from Sigma Aldrich. The procedure for the reactions above was as follows. Sodium carboxycellulose (1 g, 1.43 nmol, 1 equiv) was dissolved in 200 mL of de-ionized water and 1-ethyl-3-(3-dimethylaminopropyl)-carbodiimide hydrochloride (863.2 mg, 4.5 mmol, 3146 equiv) was added to this solution. An aqueous solution of HCl (1N) was then added until pH reached 6 to convert the carboxylic acid groups from salt form to free acidic form. Aminobenzoboroxole (834.3 mg, 4.5 mmol, 3146 equiv) was dissolved in 5 mL of de-ionized water and NaOH solution (1M) was added until pH reached 7 to convert the amino groups from salt form to free base form. The two solutions were then mixed and the mixture was stirred at room temperature for 4 days. The product polymer (designated CMC-BBX) was purified by dialysis and freeze-dried overnight.

The amount of boron within the polymer was measured by ICP-MS which showed that the compound contained an average of 297 boron atoms per carboxymethylcellulose chain. Aqueous solutions were prepared containing 0.2 wt % guar and 0.2 wt % of the above CMC-BBX polymer containing boroxole groups. This provided approximately 8.6 ppm boron in solution. These solutions were prepared with pH 8, pH 9, pH 10 and pH 11. It was observed that all these solutions were visibly more viscous then a 0.2% wt % guar solution with no cross linker and it was also apparent that viscosity increased with pH.

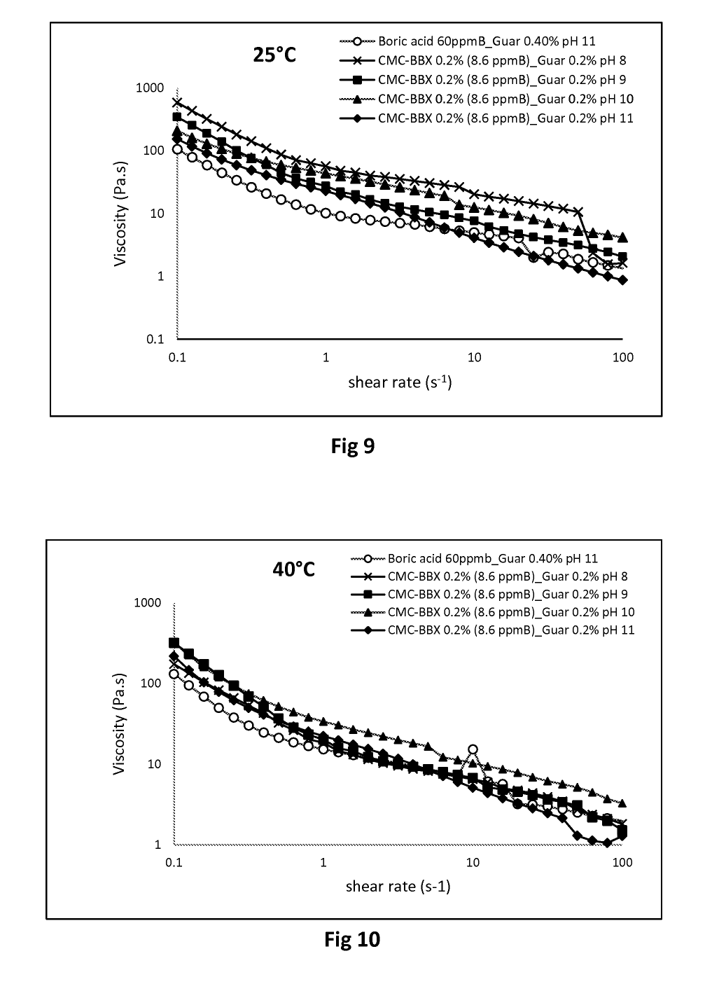

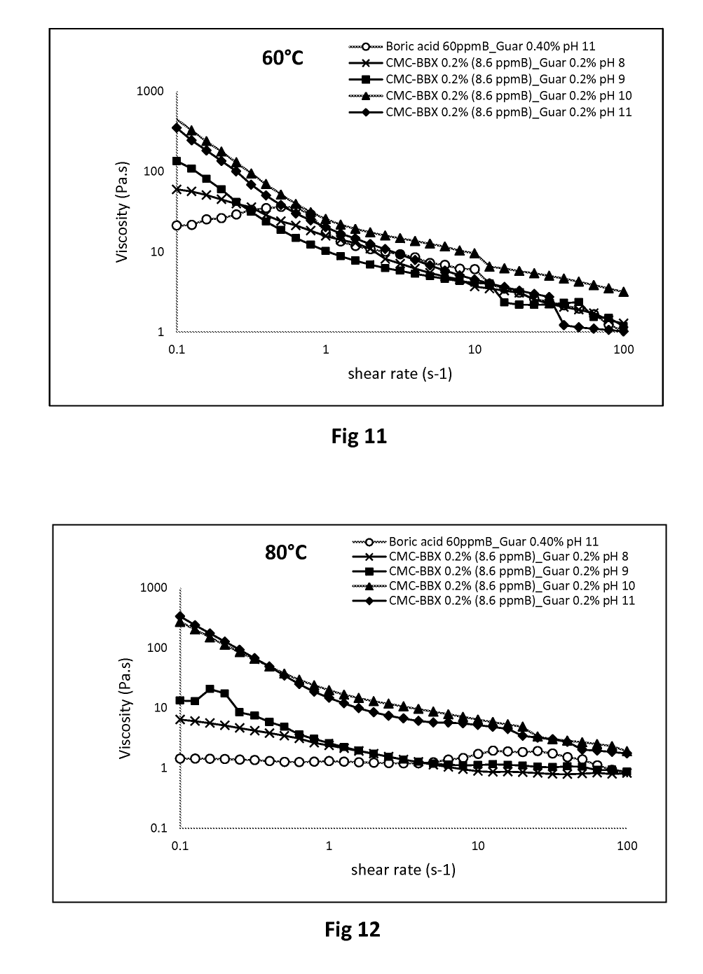

Viscosities of the solutions were measured at various temperatures and shear rates. The same measurements were made on a comparative solution prepared at pH 11 containing 0.4 wt % guar and sufficient boric acid to provide 60 ppm boron in solution. The results at four temperatures are shown in FIGS. 9 to 12. The compositions thickened with CMC-BBX generally gave a viscosity equal to or better than that of the comparative solution, even though the comparative solution contained more guar and more boron.

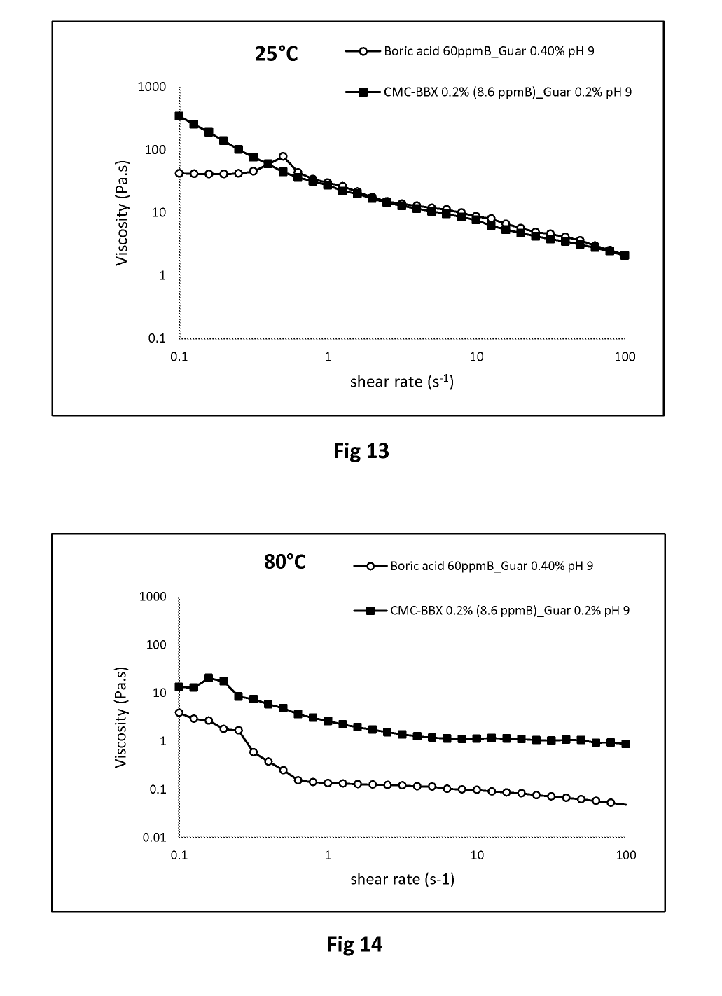

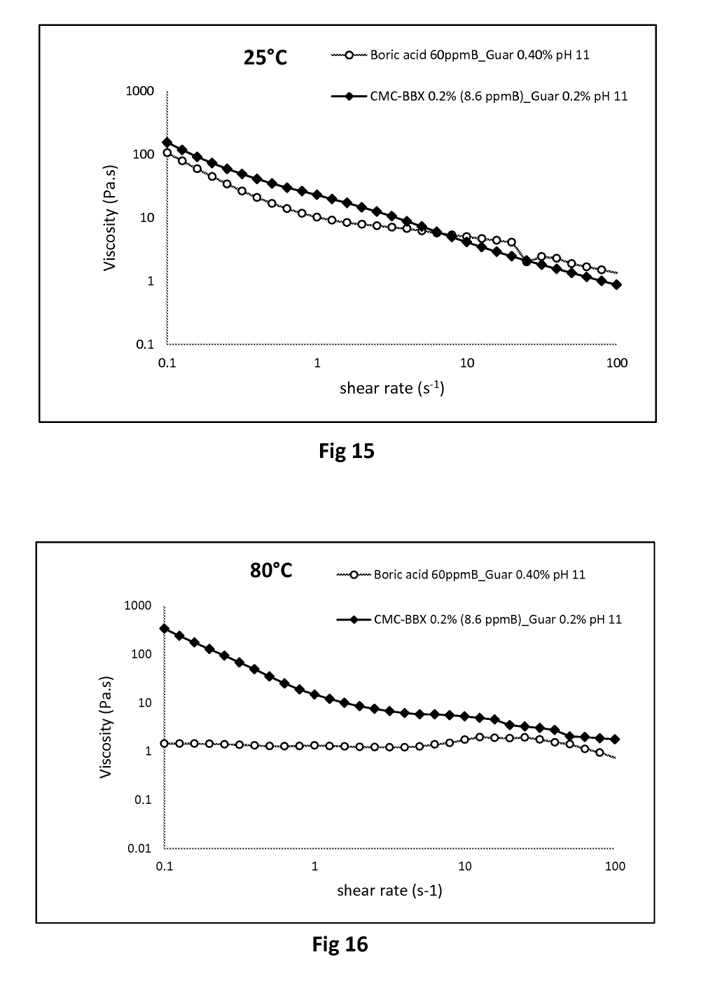

To illustrate this further, FIGS. 13 and 14 show the measurements at 25° C. and 80° C. on the solution at pH 9 together with measurements on a comparative solution also prepared at pH 9 containing 0.4 wt % guar and sufficient boric acid to provide 60 ppm boron in solution. FIGS. 15 and 16 show the equivalent measurements (which were present in FIGS. 9 and 12) on the solution and comparative solution at pH 11. It can be seen from FIGS. 15 and 16 that the solution made at pH 11 using the crosslinker of this example gave similar thickening at 80° C. to that at 25° C.

It will be appreciated that the example embodiments described in detail above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A thickened aqueous fluid comprising a thickening polymer with diol groups distributed along it and a cross-linker for the polymer where the cross-linker contains a plurality of groups of the partial formula 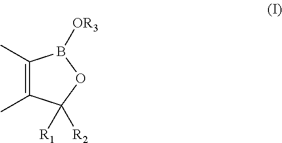
wherein R₁ is hydrogen or a substituent group or an attachment to the remainder of the cross-linker molecule, R₂ is hydrogen or a substituent group, R₃ is hydrogen or an aliphatic or aromatic group and the carbon atoms joined by a double bond are part of an aromatic ring.

2. A thickened aqueous fluid according to claim 1 wherein the crosslinker is a water soluble polymer with a plurality of the groups of formula (I) attached thereto.

3. A thickened aqueous fluid according to claim 1 wherein the crosslinker comprises nanoparticles with a plurality of the groups of formula (I) attached to the exterior of the nanoparticles.

4. A thickened aqueous fluid according to claim 1 wherein the polymer with diol groups is a polysaccharide.

5. A thickened aqueous fluid according to claim 4 wherein the polysaccharaide comprises guar or chemically modified guar.

6. A thickened aqueous fluid according to claim 2 wherein the crosslinker is a water soluble polysaccharide with a plurality of the groups of formula (I) attached thereto.

7. A thickened aqueous fluid according to claim 2 which has a pH in a range from pH7 to pH 10.

8. A thickened aqueous fluid according to claim 1 which has a pH in a range from pH7 to pH 8.5

9. A thickened aqueous fluid according to claim 1 which is a hydraulic fracturing fluid with particulate proppant suspended therein.

10. A method of thickening an aqueous fluid comprising incorporating into an aqueous liquid:
a water-soluble polymer with diol groups distributed along the polymer chain, and a cross-linker for the polymer where the cross-linker contains a plurality of groups of the partial formula 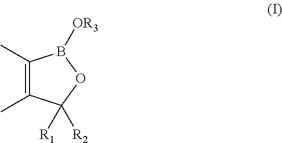
wherein R₁ is hydrogen or a substituent group or denotes an attachment to the remainder of the cross-linker molecule, R₂ is hydrogen or a substituent group, R₃ is hydrogen or an aliphatic or aromatic group and the carbon atoms joined by a double bond are part of an aromatic ring.

11. A method according to claim 10 which further comprises delivering the aqueous fluid to a subterranean location.

12. A method according to claim 11 which further comprises suspending a particulate material in the aqueous fluid.
